(19) United States
(12) Patent Application Publication
(10) Pub. No.: US 2007/0250849 A1
(43) Pub. Date: Oct. 25, 2007

(54) Method and device for media quiz

(75) Inventors: Christian Faber, Frederiksberg C (DK); Marie Kristine Schmidt, Kobenhavn N (DK)

Correspondence Address: FITCH EVEN TABIN AND FLANNERY, 120 SOUTH LA SALLE STREET, SUITE 1600, CHICAGO, IL, 60603-3406, US

(73) Assignee: Advance A/S, Copenhagen (DK)

(21) Appl. No.: 11/399,746

(22) Filed: Apr. 7, 2006

(51) Int. Cl. H04N 7/173; H04N 7/16

(52) U.S. Cl. 725/24; 725/135; 725/105

(57) ABSTRACT

A computing device is disclosed, comprising a user interface and a central processing unit for launching a session on the computing device enabling the computing device to receive media data and associated data comprising information on the media data, render the media data by the user interface, provide a question related to the rendered media data based on the associated data and receive a response by the user interface for performing a quiz, receive an indication from a user that the user wants to access content related to the media data, determine content related to the media data upon reception of the indication, and access the content. A corresponding server for provision of media data, associated data, and content is also disclosed. Further, methods for the computing device and the server are disclosed.

### TECHNICAL FIELD

The present invention relates to a computing device and a server for performing a quiz based on data associated to media data, and methods therefore.

### BACKGROUND OF THE INVENTION

There are presently disclosed methods for providing music gaming for on-line promotion of business, such as on-line music sales, on-line entertainment, on-line advertising, etc., e.g. in US 2002/0143639 A1, which is hereby incorporated by reference. The games are music trivia-based and internet based, with a front-end including a user interface providing questions to one or more users such that a user can provide an answer to the question; However, there is a need for developing gaming like this to both enhance the user experience and the ability of the provider of the gaming to do a good business out of it.

### SUMMARY OF THE INVENTION

In view of the above, an objective of the invention is to solve or at least reduce the problems discussed above. In particular, an objective is to provide a service that is pleasing to the user and providing a healthy business to the provider.

The present invention is based on the understanding that people, when they participate in a quiz game, has a different mindset than when they are visiting a music store with the purpose of purchasing music. When the users are exposed to the music, it creates emotions while taking the user on a trip down its memory lane and fills the user with memories and emotions attached to the music heard. While being at this emotional peak, it gives the user the opportunity to access content related to the rendered music clip, e.g. to purchase the music in question. The same applies to other media, such as video, or audio and video in combination. The service further activates a competitive excitement, which can be emphasized by a time factor which puts the player under pressure. The invention provides playing against the computer, friends, or in a virtual game with like minded music lovers, and the user will feel the buzz of competition. Further, the service may let the user discover new music, i.e. music that the user didn't know she wanted to hear, or rediscover music the user had forgotten, or maybe music the user didn't know she had forgotten. Further the user can be part of a quiz community and may be involved in creating the questions or information related to particular categories, genre or artists.

According to a first aspect of the present invention, there is provided a computing device comprising a user interface and a central processing unit for launching a session on the computing device enabling the computing device to receive media data and associated data comprising information on the media data, render the media data by the user interface, provide a question related to the rendered media data based on the associated data and receive a response by the user interface for performing a quiz, receive an indication from a user that the user wants to access content related to the media data, determine content related to the media data upon reception of the indication, and access the content.

A particular advantage of this is that the user is directly able to give an indication that content related to the rendered media data is something that the user would want to access in full scale. The media data may comprise audio data or video data, or a combination thereof. This may be a tune, an audio file, an album, a music video, a photo, or a motion picture clip, or any combination thereof, and the user is then able to access the related content. This can be performed by ordering it on a data carrier, such as a MD, CD, or DVD, but can preferably be directly downloadable from the provider. The computing device may thus involve means for purchasing rights to the content to access the content. Reception of the indication may comprise an actuation by a pointing means of the user interface, such as a click on a graphical item related to the media data or among one or more graphical items related to available content.

Media data should in this context be construed as data comprising information for producing any of an audio and/or video impression when rendered.

The session may comprise a quiz sub-session, and an access sub-session, wherein an identification of the media data is provided from the quiz sub-session to the access sub-session, and the access is performed by the access sub-session using the identification. Thus, the access sub-session may comprise a function for buying rights to the content. The session and the sub-sessions may be implemented by an application and sub-applications, respectively.

The received media data may comprise a selection from a set of media data. The set of media data may be at least a part of a music archive, which preferably comprises a large number of titles to make the quiz interesting. The selection from the set of media data may be limited by category, artist/group, country, genre, year, or any combination thereof. Thus, the quiz can be tailored to fit to any user. The associated data may comprises title, artist, release year, album, composer, producer, or record company, or any combination thereof. This provides for both ability to create feasible questions, and for providing relevant information to the user after the attempt to answer the question.

According to a second aspect of the present invention, there is provided a server comprising a first set of data and a second set of data, wherein the first set of data comprises a media data item and associated data, the associated data being associated to the media data item and comprising information on the media data item for enabling a quiz to be performed based on rendering the media data and a question based on the associated data, and the media data item is related to a content item in the second set of data, and the server is arranged to provide the media data item and the associated data, and the content upon access.

A particular advantage of this is that Record Labels have a unique opportunity to activate their back catalogue of media and capitalize from investments already made.

Another particular advantage of this is that the provider of the service will have an automatic provision of both the quiz functionality and the access functionality. Also here, the content may of course comprise an audio or video media. This may be a tune, an audio file, an album, a music video, a photo, or a motion picture clip, or any combination thereof. Similarly to the first aspect of the invention, the associated data may comprise title, artist, country, genre, release year, album, composer, producer, video director, chart rating, record company, or gossip, which may be questions about the artist's personal life and data, or any combination thereof.

Means of the server to provide the content may involve means for vending rights to the content. This provides for ability to sell content, and thus for ability to a healthy business.

Here, the provided media data item may comprise a selection from the first set of data. The selection from the first set of data may be limited by genre, artist, era, country, or region, or any combination thereof, such that the service can be tailored for any group of customers.

According to a third aspect of the present invention, there is provided a method for performing a quiz on a computing device comprising the steps of: receiving media data and associated data, wherein the associated data comprises information on the media data; rendering the media data by a user interface; providing a question related to the rendered media data based on the associated data and receiving a response; receiving an indication from a user that the user wants to access content related to the media data; determining content related to the media data upon reception of the indication; and enabling access to the content. The method may further comprise the steps of: logging associated data to previously rendered media data; providing logged associated data; and enabling access to content related to any of the provided logged associated data upon request. The accessing of content may comprise vending a right to the content, or providing the right to the content as a reward in the quiz, or a combination thereof. The method may further comprise the steps of: counting quiz scores related to the questions and answers; and providing purchasing offers being dependent on the quiz scores. The method may further comprise the steps of: enabling request of a hint to the correct answer of the question; and providing the hint and decreasing the score upon request of a hint. This way, the user will be able to move on smoother during gaming, and is also given the thrilling ability to gamble with acquired scores. The method may further comprise the step of determining the media data item to be received randomly from the first set of data. This provides for an experience of being surprised to be confronted with for example an old favorite, or a new piece of music that is just that right, or just experiencing the right competition feeling. The method may further comprise the step of limiting the first set of data by genre, artist, era, country, or region, or any combination thereof, to tailor the quiz. A quiz session may be assigned a time limit to enhance the competition experience. The quiz may be a competition between several users. Thus, the method may further comprise assigning a handicap to each user. The handicap may be based on an earlier quiz session. The provision of handicap may provide diversified score calculation, diversified time factors, and/or provision of questions with different rating. The diversified time factors may be applied on how fast score decreases before answering a question, an/or assigning different quiz session time limits. These features will further enhance the competition, and the handicap will enable a real music enthusiast, being more or less an expert, to compete with a more average music lover, and still get the right competition feeling.

The steps of receiving media may comprise streaming or downloading media.

According to a fourth aspect of the present invention, there is provided a method for providing a quiz on a server comprising the steps of: providing media data and associated data comprising information on the media data; providing a question related to the media data based on the associated data and receiving a response; receiving a request to access content related to the media data; determining content related to the media data upon reception of the request; and enabling access to the content. The enabling of access to the content may comprise vending the content, or providing the content as a reward in the quiz, or a combination thereof. The method may further comprise the steps of: logging the associated data to provided media data; providing information related to the logged associated data; receiving a request to access content related to any of the logged data; and enabling access to the requested content. The enabling of access to the content may comprise vending the content, or providing the content as a reward in the quiz, or a combination thereof. The method may further comprise the steps of: counting quiz scores related to the questions and answers; and providing offer to access content depending on the quiz scores. The method may further comprise the step of determining the media data to be provided randomly from a set of media data. The random provision may be biased. This enables a content provider to promote certain content. The method may further comprise the step of limiting the set of media data by genre, category, artist/band, year, country, or any combination thereof. A quiz session may be assigned a time limit. The quiz may be a competition between several users. The method may further comprise assigning a handicap to each user. The handicap may be based on an earlier quiz session.

The further advantages of the third and fourth aspects of the invention are similar to those of the first and second aspects of the invention, respectively.

Further features related to any of the above aspects may be to provide a rating of the questions, which may be used for score calculation and/or handicap management. Further, in a multiplayer session, there may be provided for a player to take another player's missed question. Further, for the multiplayer case, there may be provided challenges and/or invitations to contests.

User data, such as name, address, nickname, transaction data, or any other data for identification and purchasing/vending, may also be managed by the computing device and/or the server.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 schematically illustrates a computing device according to an embodiment of the present invention;

FIG. 2 schematically illustrates a server according to an embodiment of the present invention;

FIG. 3 schematically illustrates a system in which a server and a plurality of computing devices according to the invention operates;

FIG. 4 is a flow chart illustrating a method for performing a quiz on a computing device according to an embodiment of the present invention; and

FIG. 5 is a flow chart illustrating a method for providing a quiz on a server according to an embodiment of the present invention.

### DETAILED DESCRIPTION OF PREFERRED EMBODIMENTS

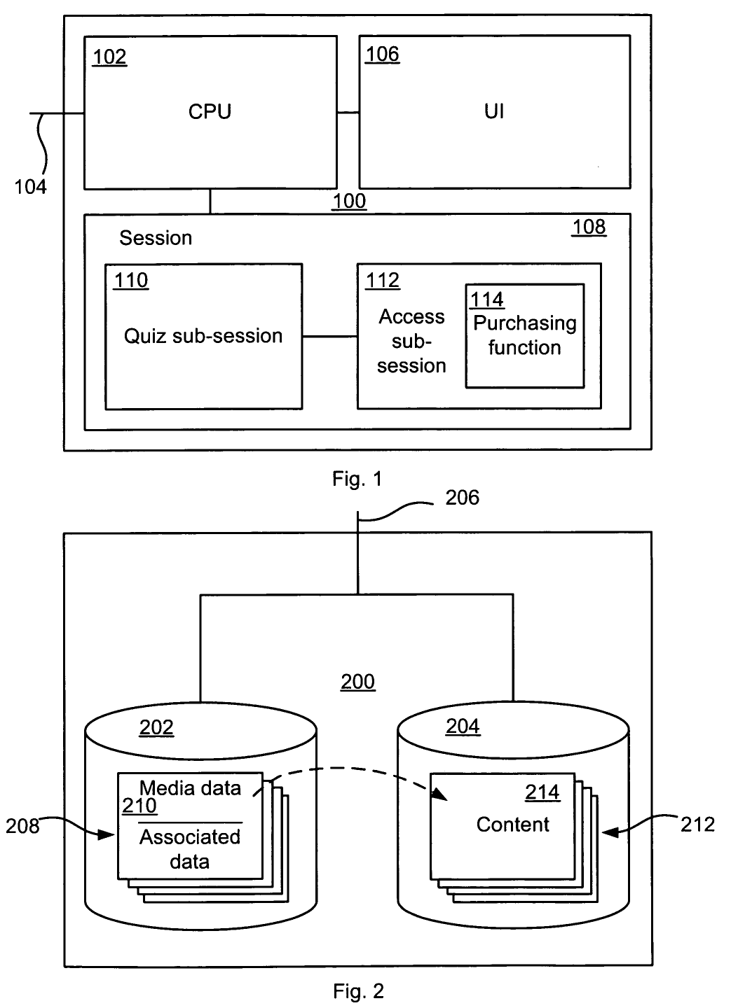

FIG. 1 schematically illustrates a computing device 100 according to an embodiment of the present invention. The computing device comprises a central processing unit (CPU) 102 having a connection 104 for providing communication to and from the computing device 100. In FIG. 1, the connection is depicted to be connected to the CPU, but this should be construed in a functional manner, and the connection can be connected to communication means (not shown) for wired and/or wireless communication, and the communication means are controlled by the CPU. The computing means further comprises a user interface (UI) 106 for user interaction, and the UI 106 can comprise display means, audio output means such as speaker or headphones, audio input means such as a microphone, other input means such as a keypad, a keyboard, a pointing device, etc. These elements are not depicted in FIG. 1 for the sake of clarity. The computing device 100 further comprises a session 108 for performing quiz and content access functions of the computing device. The session 108 per se is preferably stored in memory means (not shown) of the computing device, but can also be stored and launched, at least partly, at a remote location such as a server.

The session 108 can comprise a quiz sub-session 110 for handling quiz functionality, such as posing questions, checking answers, assigning and keeping track of scores, customizing the quiz, setting up quiz sessions, either with one or several participants, or providing hints to the gamer. The quiz session can also provide a log of previous questions and/or answers, or any related data to these. The log is preferably displayed to the gamer, or to the gamers if it is a multi-player session.

The session can also comprise an access sub-session 112. If a user of the computing device 100 feels an interest in any subject-matter related to any of the questions of the quiz, the user can indicate this via the UI 106, and then the access sub-session 112 will determine available content related to the question, and preferably available content is provided to the user through the UI, where the user can request access to the content. Upon such request, the access sub-session will enable the user to access the requested content. Then a purchasing function 114 of the access sub-session 112 will provide for that the user is able to purchase rights to the content. The content is then preferably downloaded to the computing device or to any other media player of the user, but it is also possible that the content can be delivered on a data carrier, such as a MiniDisc (MD), CompactDisc (CD), Digital Versatile Disc (DVD), etc. Financial operations of the purchasing can be performed in a number of ways known to the person skilled in the art, and are preferably performed in a secure manner.

The division into two sub-sessions is to be considered as an example provided to improve understanding of the functions of the session, and the functions of the session can be implemented in one or more sub-sessions, between which the functions of the session according to the present invention can be divided arbitrarily.

The quiz itself can be performed like this. The user pushes, clicks or touches a quickgame button, graphical items related to questions will grow on to a quiztree. The questions can be divided into several difficulty levels, e.g. three indicated by green, yellow and red. Then there can be several types of questions, e.g. three: ear/audio (music), eye/visual (music videos, cover art, photos), and a special clover/chance (enabling the user to gamble with acquired points not knowing type or level). At this stage the user's scoreboard will appear in its most simple form. The game has begun. And as the user chooses any of the graphical items a media player will appear. When the user pushes a play button, a tune will start playing and available points starts disappearing. Further, a quizlist displaying a log of information related to previous questions is provided, which works just like a playlist known from many media players. It can contain the titles of the tunes from different games the user has been playing. For example, if the user 11 seconds into the song is still not quite sure who is playing, and therefore decides its time to buy help. As the user actuates a “buy help” button, the user starts using points. Then the user gets help from a list with alternatives to answers where the user can decide to choose an answer, which hopefully for the user is the right answer. The answer or any information related to the answer appears on the quizlist. For example if the user knows the title of the song and didn't need help, she can get 10 extra points, and further the user has the chance to score an additional 10 points if she knows the album. If it is a multiplayer game the user can see the ranking on a scoreboard. At any time the user can make a purchase by pushing a purchasing button. On the scoreboard the user can check the amount of points currently held. When the game is over, the points can for example be given only to the winner of the game. The points can be an equation of time, number of questions, speed and rating. The points can be used for purchasing tunes and merchandise from the gaming site.

Alternatively, the quiz can be performed like this. If user chooses quiz setup button when she enters the game instead of the quick game button as described above, she is allowed to customize the quiz to meet more specific criteria that is of interest to her. The user can choose just a single parameter e.g. Genre-Pop and keep the rest random, or the user can go for a certain artist in a certain release year. The number of combinations are infinite. Further, the appearance of the displayed gaming view can be adapted in line with the chosen parameters.

The quiz can further provide particular questions, preferably randomly or based on a biased random for promoting certain content, being related to a certain reward, such as tickets to concerts. This provides for positive surprises for the players.

The computing device can be a mobile telephone terminal, a personal digital assistant, a personal computer, a portable media player, a home movie system, a set top box, a game console, a television set, or any other device able to render media and interact with a user as described above.

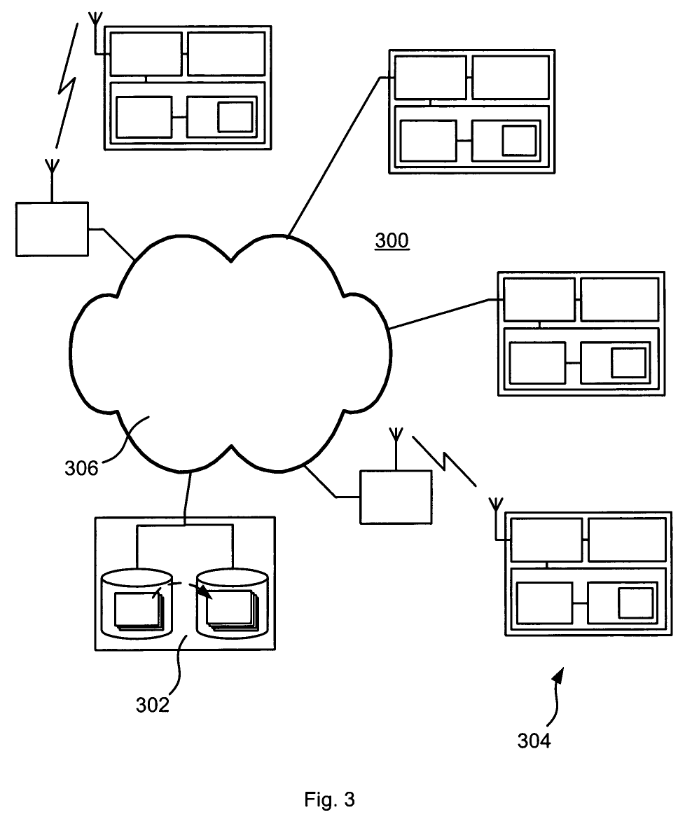

FIG. 2 schematically illustrates a server 200 according to an embodiment of the present invention. The server 200 comprises data base means 202, 204, which physically can be in stored in one or many locations, having a connection 206 for providing communication to and from the server 200. A first set of data 208 in the data base means 202 comprises a media item 210 comprising media data and data associated to the media data, such as title, artist, release year, album, composer, producer, record company, genre, era, etc. Information of the media item 210 is then used for performing a quiz similar to what described above. The quiz can be performed either on the server 200 or on a client (not shown) connected to the server 200, e.g. via a network (not shown). The quiz can also be a divided task between the server 200 and the client. Further, a second set of data 212 in the data base means 204 comprises one or more content items 214 comprising content being related to the media item 210 as depicted by dashed arrow. The content can be a tune, an audio file, an album, a music video, or a motion picture, or any combination thereof. Thus, the server 200 is able to determine one or more content item related to a media item and provide the content when requested by the client. The client can be a computing device as the one demonstrated with reference to FIG. 1, but depending on how much complexity that is chosen to put in the server, the client can also be a so called thin client. A thin client is a computer (client) in client-server architecture networks which has little or no application logic, so it has to depend primarily on the central server for processing activities.

FIG. 3 schematically illustrates a system 300 in which a server 302 and a plurality of clients 304 are interconnected via a network 306. The connections can be wired and/or wireless. With reference to the quiz described above, media data and content are provided from the server 302 to one or more clients 304 participating in the quiz. Each client 304 participating in the quiz provides user interaction, i.e. rendering media clips, posing questions, prompting answers, and receiving requests for access to content. Other parts of the quiz and content access functions can be divided arbitrarily between the participating client and the server. How this is chosen to be divided can be determined from considerations about available bandwidth between the client and the server, available processing power at the client, or business model for the quiz.

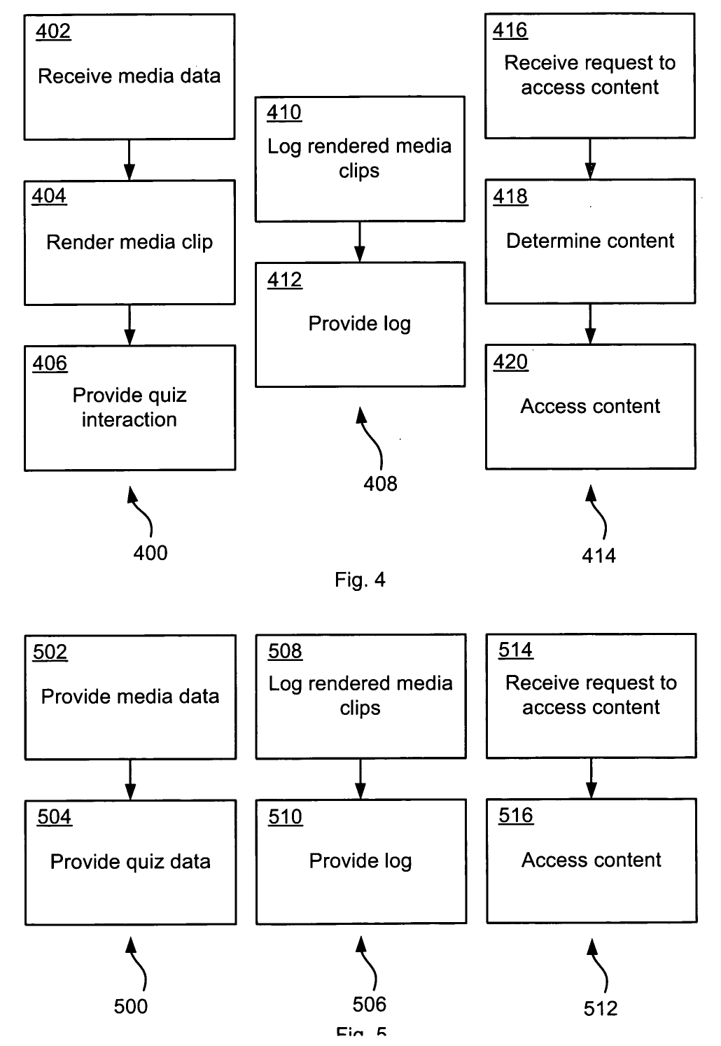

FIG. 4 is a flow chart illustrating a method for a client. It should be noted that the steps can be performed in any order, or in parallel, as long as data required to perform the step is available.

As depicted in FIG. 4, the method can be considered as several processes, where a quiz process 400 comprises a media data reception step 402, a media rendering step 404, and a quiz interaction step 406. In the media data reception step 402, media data comprising a media clip is received, e.g. from a server. The media clip is rendered in the media rendering step 404 and the quiz interaction step 406 a question related to the media clip is provided to a user, from whom an answer is prompted. The quiz interaction step 406 can also comprise steps for providing hints, etc. as described above in connection with the description of how the quiz is performed. The quiz process 400 is repeated as long as a quiz session is in progress, which for example can be limited by time or number of questions.

The method can also comprise a log process 408 comprising a log step 410 and a log presentation step 412. In the log step 410, rendered media clips are logged, and the log of media clips is provided in the log presentation step 412, where for example representative associated data to the media clip is presented, e.g. title, or title and artist.

The method further comprises an access process 414 comprising a request reception step 416, a content determination step 418, and a content access step 420. In the request reception step 416, a request from a user is received indicating that the user is interested in accessing content related to the rendered media clip or any of the media clips in the log. In the content determination step 418, available content related to the rendered media clip or any of the media clips in the log is determined. This can for example be performed upon a request related to a media clip, or be performed prior a request to enable a user to see what content that is available for the media clip, and then is able to request access to the content. Upon request to a content, the content is accessed in the content access step 420. The access can be performed in several ways, as those described above.

FIG. 5 is a flow chart illustrating a method for a server. It should be noted that the steps can be performed in any order, or in parallel, as long as data required to perform the step is available.

As depicted in FIG. 5, the method can be considered as several processes, where a quiz process 500 comprises a media data provision step 502, and a quiz data provision step 504. In the media data provision step 502, media data comprising a media clip is provided, e.g. to a client. Preferably, the media clip is rendered and a question related to the media clip is provided to a user, from whom an answer is prompted at the client. Here, providing of hints, etc. as described above in connection with the description of how the quiz is performed can be performed in the client. For provision of these actions, the server provides quiz data in the quiz data provision step. The quiz process 500 is repeated as long as a quiz session is in progress, which for example can be limited by time or number of questions.

The method can also comprise a log process 506 comprising a log step 508 and a log provision step 510. In the log step 508, provided media clips are logged, and the log of media clips is provided in the log provision step 510, where for example representative associated data to the media clip is presented, e.g. title, title and artist, or an identifier.

The method further comprises an access process 512 comprising a request reception step 514, and a content access step 516. In the request reception step 514, a request from a client is received indicating that the client is apt to access content related to a provided media clip or any of the media clips in the log. Available content related to the rendered media clip or any of the media clips in the log can be determined. This can for example be performed upon a request related to a media clip, or be performed in connection with providing the media clip in the quiz process 500 to enable a client to have information what content is available for the media clip, and then is able to request access to the content. Upon request to a content, access to the content is provided in the content access step 516. The access can be performed in several ways, as those described above.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A computing device comprising a user interface and a central processing unit for launching a session on the computing device enabling the computing device to
receive media data and associated data comprising information on the media data,
render the media data by the user interface,
provide a question related to the rendered media data based on the associated data and receive a response by the user interface for performing a quiz,
receive an indication from a user that the user wants to access content related to the media data,
determine content related to the media data upon reception of the indication,
access the content.

2. The computing device according to claim 1, wherein the computing device involves means for purchasing rights to the content to access the content.

3. The computing device according to claim 1, wherein the session comprises a quiz sub-session, and an access sub-session, wherein an identification of the media data is provided from the quiz sub-session to the access sub-session, and the access is performed by the access sub-session using the identification.

4. The computing device according to claim 3, wherein the access sub-session comprises a function for buying rights to the content.

5. The computing device according to claim 1, wherein the content comprises a tune, an audio file, an album, a music video, a photo, or a motion picture, or any combination thereof.

6. The computing device according to claim 1, wherein reception of the indication comprises an actuation by a pointing means of the user interface.

7. The computing device according to claim 1, wherein received media data comprises a selection from a set of media data.

8. The computing device according to claim 7, wherein the selection from the set of media data is limited by genre, artist, year, or era, or any combination thereof.

9. The computing device according to claim 1, wherein the associated data comprises title, artist, country, genre, release year, album, composer, producer, video director, chart rating, record company, or gossip, or any combination thereof.

10. The computing device according to claim 1, wherein the media data comprises audio data or video data, or a combination thereof.

11. A server comprising a first set of data and a second set of data, wherein
the first set of data comprises a media data item and associated data, the associated data being associated to the media data item and comprising information on the media data item for enabling a quiz to be performed based on rendering the media data and a question based on the associated data, and the media data item is related to a content item in the second set of data, and
the server is arranged to provide the media data item and the associated data, and the content upon access.

12. The server according to claim 11, wherein the content comprises a tune, an audio file, an album, a music video, a photo, or a motion picture, or any combination thereof.

13. The server according to claim 11, wherein the associated data comprises title, artist, country, genre, release year, album, composer, producer, video director, chart rating, record company, or gossip, or any combination thereof.

14. The server according to claim 11, wherein means of the server to provide the content involves means for vending rights to the content.

15. The server according to claim 11, wherein the provided media data item comprises a selection from the first set of data.

16. The server according to claim 15, wherein the selection from the first set of data is limited by category, genre, artist, group, year, era, country, or region, or any combination thereof.

17. A method for performing a quiz on a computing device comprising the steps of:
receiving media data and associated data, wherein the associated data comprises information on the media data;
rendering the media data by a user interface;
providing a question related to the rendered media data based on the associated data and receiving a response;
receiving an indication from a user that the user wants to access content related to the media data;
determining content related to the media data upon reception of the indication; and
enabling access to the content.

18. The method according to claim 17, further comprising the steps of:
logging associated data to previously rendered media data;
providing logged associated data; and
enabling access to content related to any of the provided logged associated data upon request.

19. The method according to claim 17, wherein the accessing of content comprises vending a right to the content, or providing the right to the content as a reward in the quiz, or a combination thereof.

20. The method according to claim 17, further comprising the steps of:
counting quiz scores related to the question and answer; and
providing purchasing offers being dependent on the quiz scores.

21. The method according to claim 20, further comprising the steps of:
enabling request of a hint to the correct answer of the question; and
providing the hint and decreasing the score upon request of a hint.

22. The method according to claim 17, further comprising the step of determining the media data item to be received randomly from the first set of data.

23. The method according to claim 22, further comprising the step of limiting the first set of data by genre, artist, era, or any combination thereof.

24. The method according to claim 17, wherein a quiz session is assigned a time limit.

25. The method according to claim 17, wherein the quiz is a competition between several users.

26. The method according to claim 25, further comprising assigning a handicap to each user.

27. The method according to claim 26, wherein the handicap is based on an earlier quiz session.

28. The method according to claim 17, wherein the media data comprises audio data or video data, a combination thereof.

29. A method for providing a quiz on a server comprising the steps of:
providing media data and associated data comprising information on the media data;
providing a question related to the media data based on the associated data and receiving a response;
receiving a request to access content related to the media data;
determining content related to the media data upon reception of the request; and
enabling access to the content.

30. The method according to claim 29, wherein the enabling of access to the content comprises vending the content, or providing the content as a reward in the quiz, or a combination thereof.

31. The method according to claim 29, further comprising the steps of:
logging the associated data to provided media data;
providing information related to the logged associated data;
receiving a request to access content related to any of the logged data; and
enabling access to the requested content.

32. The method according to claim 31, wherein the enabling of access to the content comprises vending the content, or providing the content as a reward in the quiz, or a combination thereof.

33. The method according to claim 29, further comprising the steps of:
counting quiz scores related to the questions and answers; and
providing offer to access content depending on the quiz scores.

34. The method according to claim 29, further comprising the step of determining the media data to be provided randomly from a set of media data.

35. The method according to claim 34, wherein the random provision is biased.

36. The method according to claim 34, further comprising the step of limiting the set of media data by category, genre, artist, group, era, year, or any combination thereof.

37. The method according to claim 29, wherein a quiz session is assigned a time limit.

38. The method according to claim 29, wherein the quiz is a competition between several users.

39. The method according to claim 38, further comprising assigning a handicap to each user.

40. The method according to claim 37, wherein the handicap is based on an earlier quiz session.

41. The method according to claim 29, wherein the media data comprises audio data or video data, or a combination thereof.
